(19) United States
(12) Patent Application Publication
(10) Pub. No.: US 2008/0115186 A1
(43) Pub. Date: May 15, 2008

(54) DISPLAY APPARATUS, SET-TOP BOX AND DISPLAY SYSTEM AND DISPLAY METHOD THEREOF

(75) Inventor: Eun-seop Cho, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: Samsung Electronics Co., Ltd., Suwon-si (KR)

(21) Appl. No.: 11/781,493

(22) Filed: Jul. 23, 2007

(30) Foreign Application Priority Data
Nov. 14, 2006 (KR) 10-2006-0112386

(51) Int. Cl. H04N 7/173; G06F 3/038; G09G 3/00

(52) U.S. Cl. 725/131; 345/204; 345/30

(57) ABSTRACT

A display apparatus includes a display; a communication part which receives an image signal and information corresponding to a first image to be displayed on an external display apparatus and transmits a control signal to adjust the first image; an image processing part which performs image processing to display an image on the display; and a controller which controls the image processing part and the communication part to display the information corresponding to the first image on the display and to transmit the control signal to adjust the first image.

### CROSS-REFERENCE TO RELATED APPLICATIONS

This application claims priority from Korean Patent Application No. 2006-0112386, filed on Nov. 14, 2006 in the Korean Intellectual Property Office, the disclosure of which is incorporated herein by reference.

### BACKGROUND

1. Technical Field

Apparatuses and methods consistent with the present invention relate to a display apparatus, a set-top box, a display system and a display method thereof, more particularly, to a display system which is capable of controlling an image displayed on a display apparatus and a display method thereof.

2. Description of the Related Art

A display apparatus outputs images based on image signals. A digital television (TV) system having a display apparatus is classified into a separation-type system, where a set-top box for receiving the image signals and a TV for processing and displaying the image signals are provided separately, and an integration-type system where a set-top box and a TV are provided as a single body. In a separation-type digital TV system, a plurality of TVs receive the image signals through a single set-top box and display separate images, respectively.

In a separation-type digital TV system, however, as the set-top box transmits the image signals to the TVs to one side, it is not easy for a user watching a digital TV to check images displayed on other digital TVs.

Further, it should not be difficult for a user who is authorized to adjust an image displayed on an external TV, e.g., to block image display or to change a channel, for various purposes such as education or the like.

### SUMMARY

The present invention provides a display apparatus, a set-top box, a display system and a display method of the display system which receives information on an image displayed on an external display apparatus to adjust it.

The present invention also provides a display apparatus, a set-top box, a display system and a display method of the display system which transmits/receives a message to/from an external display apparatus so that users watching different display apparatuses may communicate with each other.

According to an aspect of the present invention, there is provided a display apparatus comprising a display; a communication part which receives an image signal and information on a first image to be displayed on an external display apparatus and transmits a control signal to adjust the first image; an image processing part which performs image processing to display an image on the display; and a controller which controls the image processing part and the communication part to display the information on the first image on the display and to transmit the control signal to adjust the first image.

The first image may be adjusted by at least one of power on/off and change of a channel of the external display apparatus.

The display apparatus may further comprise a user input part which inputs a control signal to adjust the first image.

The controller may control the communication part to receive an image signal corresponding to a second image and the image processing part to display the second image along with the first image on a screen simultaneously.

The controller may perform the control after checking whether a user is authorized to adjust the first image.

The display apparatus may further comprise a user interface generating part which generates a user interface to show an adjusting item of the first image, wherein the controller controls to adjust the first image through the user interface.

The communication part may receive the image signal and transmit the control signal through a wireless local area network (LAN).

The controller may receive a message from a user and transmit it to the external display apparatus.

According to another aspect of the present invention, there is provided a set-top box comprising at least one receiving part which receives an image signal; a plurality of communication parts which transmit the image signal to an external display apparatus and transmit/receive information on the image signal and a control signal to adjust an image displayed on the external display apparatus to/from the external display apparatus; and a controller which transmits the image signal to the external display apparatus, a received information to a second display apparatus if receiving information on a first image displayed on a first display apparatus, and a received control signal to the first display apparatus if receiving the control signal from the second display apparatus.

The first image may be adjusted by at least one of power on/off and change of a channel of the external display apparatus.

The controller may control the communication parts to receive an image signal corresponding to a second image through the receiving part and to transmit image signals corresponding to the first image and the second image to the second display apparatus.

The communication parts may receive the image signals and transmit control signal through a wireless local area network.

The controller may transmit a message received through the communication parts to the external display apparatus so that the first display apparatus and the second display apparatus transmit/receive a message therebetween.

According to another aspect of the present invention, there is provided a display system comprising a first display apparatus which displays a first image; a second display apparatus which receives information on the first image to display it and transmits a control signal to adjust the first image; and a set-top box which receives the information on the first image to transmit it to the second display apparatus and receives the control signal from the second display apparatus to transmit it to the first display apparatus.

The set-top box may be formed in a single body with the first display apparatus or the second display apparatus.

The first image may be adjusted by at least one of power on/off and change of a channel of the external display apparatus.

The second display apparatus may display the second image along with the first image on a screen simultaneously.

The second display apparatus may check whether a user is authorized to adjust the first image and adjusts the first image.

The first display apparatus and the second display apparatus may be connected to the set-top box through a wireless local area network.

The first display apparatus and the second display apparatus may transmit/receive a predetermined message displayed on the first image and the second image through the set-top box.

According to another aspect of the present invention, there is provided a display method of a display system which comprises a display apparatus and a set-top box, comprising receiving information on a first image displayed on a first display apparatus by the set-top box; transmitting the information on the first image to a second display apparatus by the set-top box; displaying the information on the second image by the second display apparatus; transmitting a control signal inputted according to a user's instruction to adjust the first image to the set-top box by the second display apparatus; and receiving and delivering the control signal to the first display apparatus by the set-top box.

The set-top box may be formed in a single body with the first display apparatus or the second display apparatus.

The first image may be adjusted by at least one of power on/off and change of a channel of the external display apparatus.

The displaying the information on the first image may comprise displaying a second image along with the first image on a screen simultaneously.

The transmitting the control signal further may comprise checking whether a user is authorized to adjust the first image to receive the control signal.

The transmitting the image signal and transmitting/receiving the control signal may be performed through a wireless local area network.

The transmitting the control signal may further comprise receiving a predetermined message displayed on the first image and the second image, and the delivering further comprises delivering the message to the first display apparatus and the second display apparatus.

### BRIEF DESCRIPTION OF THE DRAWINGS

The aspects of the present invention will become apparent and more readily appreciated from the following description of exemplary embodiments, taken in conjunction with the accompanying drawings, in which:

FIG. 1 illustrates a configuration of a display apparatus according to an exemplary embodiment of the present invention.

FIG. 2 is a block diagram illustrating a configuration of a set-top box according to an exemplary embodiment of the present invention.

FIG. 3 is a block diagram illustrating a configuration of a display system according to an exemplary embodiment of the present invention.

FIG. 4 illustrates a user interface of a display apparatus according to an exemplary embodiment of the present invention.

FIG. 5 is a flow chart illustrating a display method of a display system according to an exemplary embodiment of the present invention.

### DETAILED DESCRIPTION OF EXEMPLARY EMBODIMENTS

Reference will now be made in detail to exemplary embodiments of the present invention, which are illustrated in the accompanying drawings, wherein like reference numerals refer to like elements throughout. Exemplary embodiments are described below so as to explain the present invention with reference to the accompanying drawings.

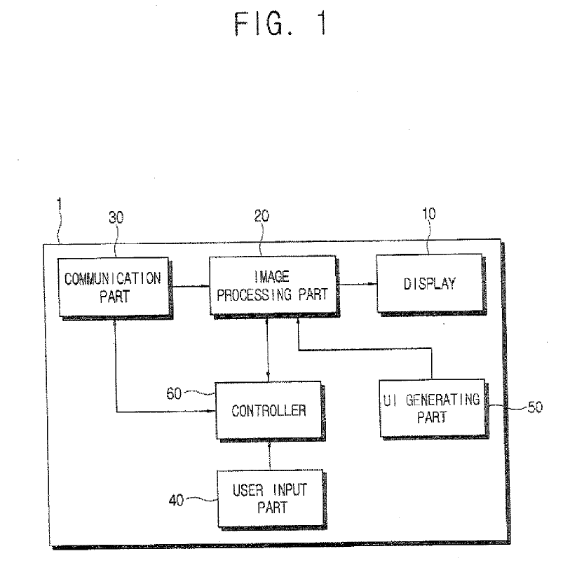

Referring to FIG. 1, a display apparatus 1 according to an exemplary embodiment of the present invention includes a display 10, an image processing part 20, a communication part 30, a user input part 40, a user interface (UI) generating part 50 and a controller 60. The display apparatus 1 may be provided as a digital TV, for instance.

The display 10 displays an image based on an image signal which is processed by the image processing part 20. The display 10 may be provided, for example, as a cathode ray tube (CRT), a liquid crystal display (LCD), a plasma display panel (PDP), a digital light processing (DLP) display, a surface-conduction electron-emitter display (SED), a field emission display (FED), and other known displays in the art.

The image processing part 20 processes an image signal which the communication part 30 receives to be displayed on the display 10 as an image. Further, the image processing part 20 processes information corresponding to a first image which the communication part 30 receives to be displayed on the display 10 as an image.

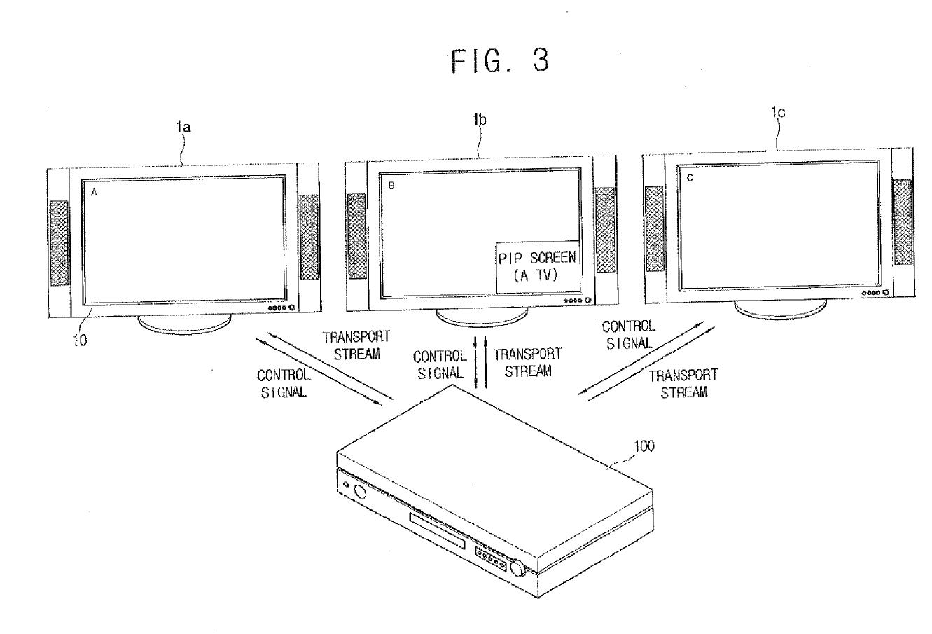

The image processing part 20 may perform image processing to display a first image displayed on a first display apparatus 1a (shown in FIG. 3) and a second image in Picture-in-Picture (PIP) mode according to control by the controller 60.

The image processing part 20 may receive a user interface (UI) image generated by the UI generating part 50 to generate images including the UI image and display them on the display 10 according to control by the controller 60. If the image processing part 20 receives a message through the communication part 30, it may process the received message to be displayed on the display 10 as an image.

The image processing part 20 according to the present exemplary embodiment may perform decoding to extract image information from an image signal, scaling to adjust resolution of an image decoded according to characteristics of the display 10 and user's setup, and picture enhancement to improve an image quality.

The communication part 30 receives an image signal and the information corresponding to the first image displayed on the first display apparatus 1a from a set-top box 100 and transmits a control signal for adjusting the first image to the set-top box 100.

The communication part 30 according to the present exemplary embodiment may be provided as a wireless local area network (LAN) for communication. Further, the communication part 30 may be provided as various configurations, e.g., a module for Bluetooth or Zigbee, a wireline communication and other known communication methods in the art, as long as such methods are to connect electronic equipments to send/receive a control signal.

The user input part 40 inputs an instruction to adjust the first image from a user. The user input part 40 according to the present exemplary embodiment may be provided, for example, at one side of a main body of the display apparatus 1. If the user input part 40 is provided as a wireless remote control, the wireless remote control may include a menu key and a key signal generating part for generating a key signal according to key operation.

The user input part 40 may receive a message from the user. Number keys provided on the wireless remote control are assigned corresponding letters, respectively so that the user can input text through the number keys.

The UI generating part 50 generates a user interface for displaying an adjustment item of the first image. The user interface generated by the UI generating part 50 will be described in greater detail below.

The controller 60 controls the image processing part 20 to display the information corresponding to the first image and controls the communication part 30 to transmit a control signal to adjust the first image according to a user's instruction.

If receiving the user's instruction to adjust the first image, the controller 60 receives the information corresponding to the first image from the set-top box 100 through the communication part 30.

The controller 60 controls the image processing part 20 to display the information corresponding to the first image received from the set-top box 100 on the display 10. Here, the controller 60 may receive an image signal corresponding to the first image to display the first image on the display 10. The controller 60 may display a second image displayed on a second display apparatus 1b as a main screen and the first image displayed on the first display apparatus 1a as a subsidiary screen. Thus, the user may watch the first image displayed on the first display apparatus 1a through the second display apparatus 1b.

If the user enters an input to adjust the first image displayed on the second display apparatus 1b via the information corresponding to the first image, then the controller 60 transmits a control signal to adjust the first image to the set-top box 100 through the communication part 30. If receiving the control signal from the second display apparatus 1b, then the set-top box 100 transmits the control signal to the first display apparatus 1a. Thus, the second display apparatus 1b can adjust the first image display on the first display apparatus 1a.

According to this exemplary embodiment, the control signal to adjust the first image includes a control signal to power on/off the first display apparatus 1a and to change a channel of the first display apparatus 1a. In addition, the control signal may further include a control signal to change the properties and the configuration of the first image, such as brightness of an image, turning-off time, etc.

The controller 60 may receive a predetermined message from the user and transmit such a predetermined message to the set-top box 100. The set-top box 100 then transmits the message to the first display apparatus 1a, and accordingly a user using the first display apparatus 1a may communicate with a user using the second display apparatus 1b.

The display apparatus 1 may be provided as a TV integrated with a set-top box 100. According to this exemplary embodiment, the information corresponding to the first image may be delivered from the first display apparatus 1a to the second display apparatus 1b, and the control signal may be delivered from the second display apparatus 1b to the first display apparatus 1a.

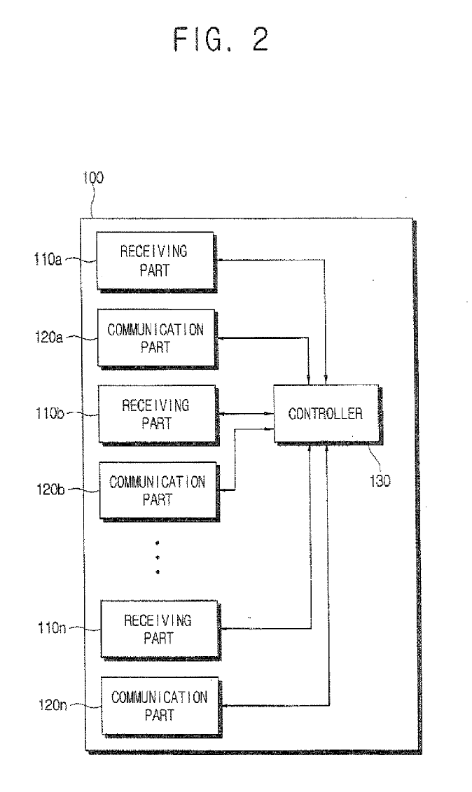

Hereinafter, the set-top box 100 according to an exemplary embodiment of the present invention will be described with reference to FIG. 2. The set-top box 100 includes at least one receiving part 110a, 110b . . . 110n, a plurality of communication parts 120a, 120b . . . 120n and a controller 130.

The at least one receiving part 110a, 110b . . . 110n receives an image signal and may be provided as a tuner, for example. In general, the number of receiving parts 110a, 110b . . . 110n is equal to or greater than the number of display apparatuses 1a, 1b, 1c . . . 1n which are connected to the set-top box 100. However, if the display apparatus 1 receives an image signal that is inputted from an external device and displays such an image signal, then the number of receiving parts 110a, 110b . . . 110n provided may be fewer than the number of display apparatuses 1a, 1b, 1c . . . 1n.

The communication parts 120a, 120b . . . 120n, respectively, transmit an image signal and information corresponding to a first image to an external display apparatus 1b and transmit/receive a control signal to adjust an image displayed on an external display apparatus 1a to/from the external display apparatuses 1a and 1b according to user's instructions. The communication parts 120a, 120b . . . 120n communicate through a wireless LAN and the number of communication parts 120a, 120b . . . 120n provided is equal to or greater than the number of display apparatuses 1a, 1b, 1c . . . 1n connected to the set-top box 100.

The communication parts 120a, 120b . . . 120n of the set-top box 100 may be provided as various configurations, e.g., a module for Bluetooth or Zigbee and a wireline communication, as long as such configurations connect electronic equipments to transmit/receive a control signal as well as the communication part in the display apparatus 1.

The controller 130 receives a control signal from the external display apparatus 1b and controls the communication parts 120a, 120b . . . 120n to transmit the control signal to the external display apparatus 1a so as to adjust an image. Thus, the second display apparatus 1b may adjust the first image displayed on the first display apparatus 1a.

The controller 130 receives a predetermined message from the second display apparatus 1b and sends it to the first display apparatus 1a. Also, the controller 130 receives a message from the first display apparatus 1a and sends it to the second display apparatus 1b. Accordingly, a user using the first display apparatus 1a can communicate with a user using the second display apparatus 1b.

As described above, the set-top box 100 may be provided in the display apparatus 1 as a single body. According to this exemplary embodiment, the information corresponding to the first image may be delivered from the first display apparatus 1a to the second display apparatus 1b, and the control signal may be delivered from the second display apparatus 1b to the first display apparatus 1a.

Hereinafter, a display system according to an exemplary embodiment of the present invention will be described with reference to FIG. 3.

Referring to FIG. 3, a display system according to an exemplary embodiment of the present invention includes a plurality of display apparatuses 1a, 1b, 1c, etc. and the set-top box 100. In the present exemplary embodiment, the display system may be provided as a digital TV system, for example, where a TV and a set-top box are separated. Alternatively, the display system may be provided as a digital TV system where a TV and a set-top box are integrated.

The first display apparatus 1a displays a first image, and the second display apparatus 1b displays information corresponding to the first image displayed on the first display apparatus 1a and transmits a control signal to adjust the first image according to user's instructions to the set-top box 100. According to this exemplary embodiment, the information corresponding to the first image may include an image signal displayed on the first display apparatus 1a, power on/off information, channel information, and other known information in the art.

The second display apparatus 1b may check whether the user is authorized to adjust the first image and to thereby allow the user to adjust the first image displayed on the first display apparatus 1a. Authorization information may include a user's ID and a password, for example.

According to an exemplary embodiment, the control signal to adjust the first image includes a control signal to power on/off the first display apparatus 1a and a control signal to change a channel of the first display apparatus 1a. In addition, the control signal may further include a control signal to change the properties and the configuration of the first image, such as brightness of an image, turning-off time, etc.

The second display apparatus 1b may display the first image and the second image simultaneously, or may display the second image as a main screen and the first image as a subsidiary screen. Also, the second display apparatus 1b may display a plurality of first images as subsidiary screens.

The second display apparatus 1b transmits a message inputted from the user to the set-top box 100, and the set-top box 100 receives the message and transmits it to the first display apparatus 1a. If receiving the message from the set-top box 100, then the first display apparatus 1a displays the message along with the first image. The set-top box 100 receives a message received from the first display apparatus 1a and transmits it to the second display apparatus 1b, and the second display apparatus 1b displays the message along with the second image. Thus, a user watching the first display apparatus 1a can communicate with a user watching the second display apparatus 1b.

The set-top box 100 receives information corresponding to the first image and transmits it to the second display apparatus 1b. The set-top box 100 receives a control signal from the second display apparatus 1b and transmits it to the first display apparatus 1a. As described above, the set-top box 100 may transmit an image signal corresponding to the first image to the second display apparatus 1b. According to this exemplary embodiment, the set-top box 100 may transmit the image signal and transmit/receive the control signal through a wireless LAN.

Moreover, in a display system according to another exemplary embodiment of the present invention, the set-top box 100 is provided in the display apparatus 1 as a single body, and the first display apparatus 1a and the second display apparatus 1b may be provided without an additional set-top box. According to this exemplary embodiment, the second display apparatus 1b itself transmits a control signal and a message, to adjust a first image, to the first display apparatus 1a. This exemplary display system may be provided with a digital TV and a set-top box in a single body, for example.

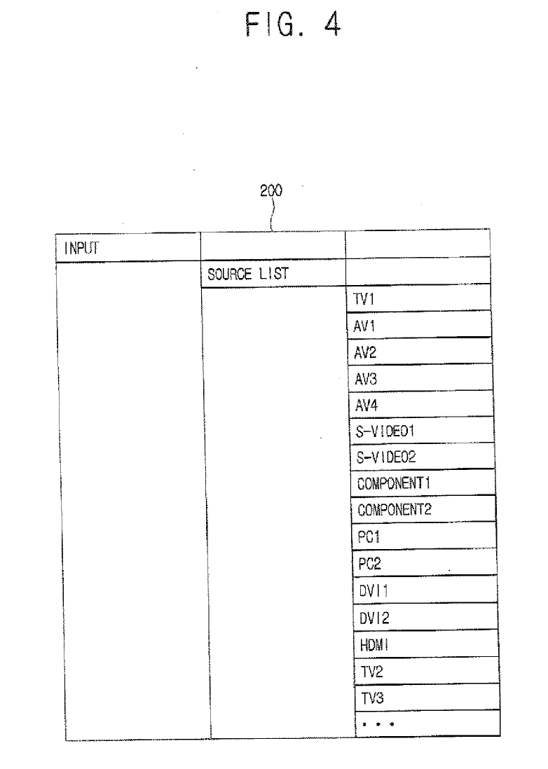

Hereinafter, the user interface displayed on the second display apparatus 1b according to an exemplary embodiment of the present invention will be described with reference to FIG. 4.

Referring to FIG. 4, the user interface 200 displayed on the second display apparatus 1b includes a source list of an image signal which inputs to the second display apparatus 1b. The source list includes not only at least one audio/video (AV) input source, an S-Video input source, a component input source, a PC input source, a digital video interface (DVI) input source, a high definition multimedia interface (HDMI) input source, but also includes a list of external display apparatuses 1a, 1c, etc., such as TV1, TV2, etc. The user interface 200 is generated by the UI generating part 50 and may be provided as an on screen display (OSD) menu and the like.

According to this exemplary embodiment, the controller 60 transmits a predetermined signal to check whether the external display apparatuses 1a, 1c, etc. are powered ON through the set-top box 100. If the external display apparatuses 1a, 1c, etc. are powered OFF, then the controller 60 inactivates the external display apparatuses 1a, 1c, etc. that are powered OFF in a list displayed in the user interface 200.

The controller 60 may display the first display apparatus 1a in addition to other image signals so that the user may select a source of the image signal to be inputted to the second display apparatus 1b through the user interface 200. If the first display apparatus 1a is selected, then the controller 60 displays the first image on the display 10, receives a control signal to adjust the first image from the user and transmits the control signal to the set-top box 100.

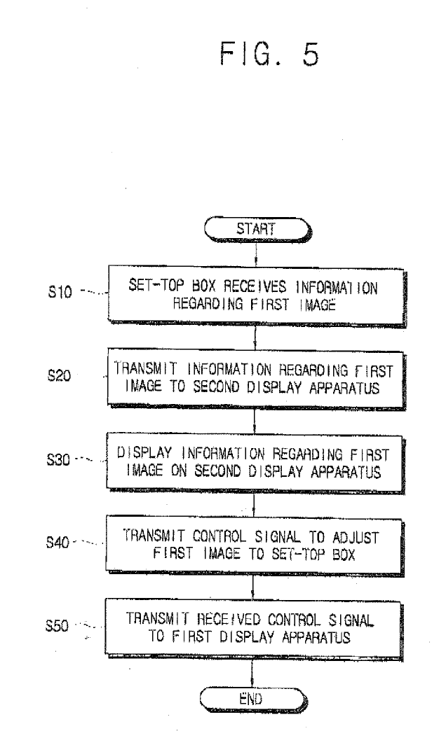

Hereinafter, a display method according to an exemplary embodiment of the present invention will be described with reference to FIG. 5.

The set-top box 100 receives information corresponding to a first image to be displayed on the first display apparatus 1a (operation S10). According to an exemplary embodiment, an image to be displayed on the first display apparatus 1a may be displayed on the second display apparatus 1b. Further, the second display apparatus 1b may simultaneously display a second image along with the first image on a screen. The set-top box 100 transmits the information corresponding to the first image to the second display apparatus 1b (operation S20).

The second display apparatus 1b displays the information corresponding to the first image thereon (operation S30). According to an exemplary embodiment, it may be checked whether the user has authority to adjust the first image through ID and password. Then, the second display apparatus 1b transmits the control signal, which inputs according to a user's instructions to adjust the first image, to the set-top box 100 (operation S40).

Finally, the set-top box 100 receives the control signal and transmits it to the first display apparatus 1a (operation S50). According to an exemplary embodiment, the second display apparatus 1b may transmit the control signal to the set-top box 100 through a wireless local area network.

If the user selects plural display apparatuses 1a and 1c, then the control signal is transmitted to the display apparatuses 1a and 1c in a predetermined order or at the same time.

Operation S20 may further include receiving a predetermined message displayed on the first and the second images. Also, operation S30 may further include transmitting the message to the first display apparatus 1a and the second display apparatus 1b.

If the set-top box 100 is provided in the display apparatus 1, the information corresponding to the first image is transmitted from the first display apparatus 1a to the second display apparatus 1b, and the control signal is transmitted from the second display apparatus 1b to the first display apparatus 1a.

Thus, the first image displayed on the first display apparatus 1a is displayed on the second display apparatus 1b, and thus the second display apparatus 1b may adjust the first image.

As described above, a display system and a display method according to exemplary embodiments of the present invention receives information corresponding to an image displayed on an external display apparatus, thereby adjusting the image displayed on the external display apparatus.

Further, a display apparatus according to exemplary embodiments of the present invention receives/transmits a message from/to the external display apparatus, and thus users watching different display apparatuses may communicate with each other.

Although a few exemplary embodiments of the present invention have been shown and described above, it will be appreciated by those skilled in the art that various changes may be made to these exemplary embodiments without departing from the principles and spirit of the invention, the scope of which is defined in the appended claims and their equivalents.

What is claimed is:

1. A display apparatus comprising:
a display;
a communication part which receives a first image signal and information corresponding to a first image that is displayed on an external display apparatus and transmits a control signal to adjust the first image;
an image processing part which performs image processing to display images on the display; and
a controller which controls the image processing part to display the information corresponding to the first image on the display and controls the communication part to transmit the control signal to adjust the first image.

2. The display apparatus according to claim 1, wherein the first image is adjusted by at least one of:
powering on or off the external display apparatus; and
changing a channel of the external display apparatus.

3. The display apparatus according to claim 1, further comprising a user input part which inputs the control signal to adjust the first image.

4. The display apparatus according to claim 1, wherein the controller controls the communication part to receive a second image signal corresponding to a second image, and
wherein the controller controls the image processing part to display the second image along with the first image simultaneously.

5. The display apparatus according to claim 3, wherein the controller controls the image processing part to display the information corresponding to the first image on the display and controls the communication part to transmit the control signal to adjust the first image, after checking whether a user is authorized to adjust the first image.

6. The display apparatus according to claim 3, further comprising a user interface generating part which generates a user interface showing an adjusting item of the first image, wherein the controller controls adjustment of the first image using the user interface.

7. The display apparatus according to claim 1, wherein the communication part receives the first image signal and transmits the control signal using a wireless local area network.

8. The display apparatus according to claim 1, wherein the controller receives a message from a user and transmits the message to the external display apparatus.

9. A set-top box comprising:
a receiving part which receives a first image signal;
a plurality of communication parts which transmit the first image signal to an external display apparatus, transmit or receive information corresponding to the first image signal, and a control signal to adjust a first image displayed on the external display apparatus; and
a controller which controls the plurality of communication parts to transmit the first image signal to the external display apparatus,
wherein, if the first image is displayed on a first external display apparatus and information corresponding to the first image displayed on the first external display apparatus is received, then the controller transmits the received information to a second external display apparatus, and
wherein, if a control signal is received from the second external display apparatus, then the controller transmits the received control signal to the first external display apparatus.

10. The set-top box according to claim 9, wherein the first image is adjusted by at least one of:
powering on or off the first external display apparatus; and
changing a channel of the first external display apparatus.

11. The set-top box according to claim 9, wherein the controller controls the communication parts to receive a second image signal corresponding to a second image, and
wherein the controller controls the communication parts to transmit image signals corresponding to the first image and the second image to the second external display apparatus.

12. The set-top box according to claim 9, wherein the communication parts receive information corresponding to the first image signal and transmit the control signal using a wireless local area network.

13. The set-top box according to claim 9, wherein the controller transmits a message received from the first external display apparatus to the second external display apparatus using the communication parts.

14. A display system comprising:
a first display apparatus which displays a first image;
a second display apparatus which receives information corresponding to the first image, displays the information corresponding to the first image, and transmits a control signal to adjust the first image; and
a set-top box which receives the information corresponding to the first image, transmits the information corresponding to the first image to the second display apparatus, receives the control signal from the second display apparatus, and transmits the control signal from the second display apparatus to the first display apparatus.

15. The display system according to claim 14, wherein the set-top box is formed in a single body with at least one of the first display apparatus and the second display apparatus.

16. The display system according to claim 14, wherein the first image is adjusted by at least one of:
powering on or off the first display apparatus; and
changing a channel of the first display apparatus.

17. The display system according to claim 14, wherein the second display apparatus displays the second image and the first image simultaneously.

18. The display system according to claim 14, wherein the second display apparatus checks whether a user is authorized to adjust the first image and, if the user is authorized to adjust the first image, then the second display apparatus adjusts the first image.

19. The display system according to claim 14, wherein the first display apparatus and the second display apparatus are connected to the set-top box through a wireless local area network.

20. The display system according to claim 14, wherein the first display apparatus and the second display apparatus transmit or receive a message corresponding to at least one of the first image and the second image using the set-top box.

21. A display method of a display system which comprises a first display apparatus, a second display apparatus and a set-top box, the method comprising:
receiving first image information corresponding to a first image displayed on the first display apparatus at the set-top box;
transmitting the first image information to the second display apparatus from the set-top box;
displaying second image information corresponding to a second image by the second display apparatus;
transmitting a control signal from the second display apparatus to the set-top box, to adjust the first image, wherein the control signal is inputted according to a user's instruction;
receiving the control signal at the set-top box; and
delivering the control signal from the set-top box to the first display apparatus.

22. The display method of the display system according to claim 21, wherein the set-top box is formed in a single body with at least one of the first display apparatus and the second display apparatus.

23. The display method of the display system according to claim 21, wherein the first image is adjusted by at least one of:
powering on or off the first display apparatus; and
changing a channel of the first display apparatus.

24. The display method of the display system according to claim 21, wherein the displaying the first image information comprises displaying the second image information along with the first image information simultaneously.

25. The display method of the display system according to claim 21, wherein the transmitting the control signal further comprises checking whether a user is authorized to adjust the first image.

26. The display method of the display system according to claim 21, wherein the transmitting the first image information, the receiving the control signal and the transmitting the control signal are performed using a wireless local area network.

27. The display method of the display system according to claim 21, wherein the transmitting the control signal further comprises receiving a message corresponding to at least one of the first image and the second image, and
wherein the delivering the control signal further comprises delivering the message to the first display apparatus and the second display apparatus.
